(19) United States
(12) Patent Application Publication
(10) Pub. No.: US 2010/0133979 A1
(43) Pub. Date: Jun. 3, 2010

(54) RC plasma jet and method

(76) Inventor: Xin Pei Lu, Wuhan (CN)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 12/459,861

(22) Filed: Jul. 8, 2009

(30) Foreign Application Priority Data
Dec. 2, 2008 (CN) 200810236697.7

(51) Int. Cl. H05H 1/24

(52) U.S. Cl. 313/231.31; 315/111.21

(57) ABSTRACT

A resistor-capacitor (“RC”) plasma jet device, produces a safe plasma for human contact. In an example embodiment, the RC plasma jet device includes a power supply, a gas supply and an electrode. A working gas can be injected into the gas inlet of the electrode from the gas supply. The electrode, is connected to the power supply through a resistance and a capacitance. The electrode may be a hollow tube with a gas inlet and a gas outlet. The device can be portable, safe, easy to operate, and inexpensive. By changing the values of the capacitor (s) and resistor (s), and using different excitation sources and working gas, the intensity and gas temperature of the plasma jet can be adjusted. When the gas temperature is close to room-temperature, the plasma jet is touchable by a human hand without an arcing risk. The plasma can also be ejected to an open space by different geometric shapes or configuration in various directions and the device can be modified or applied to many large-scale applications at room-temperature and atmospheric pressure.

### CROSS-REFERENCE TO RELATED APPLICATIONS

The present application claims the benefit of application Ser. No. 200810236697.7, filed Dec. 2, 2008, entitled Plasma Jet Device, the disclosure of which is hereby incorporated herein by reference.

### BACKGROUND OF THE INVENTION

Typically, plasma consists of ions, neutral species and electrons. In general, plasma may be classified into thermal equilibrium and thermal non-equilibrium plasmas. Thermal equilibrium implies that the temperatures of all species including ions, neutral species, and electrons, are equal.

In thermal non-equilibrium plasmas, the temperature of the ions and the neutral species is usually much lower than that of the electrons. Therefore, thermal non-equilibrium plasmas may serve as highly reactive media for applications where temperature sensitive material is treated. This “hot coolness” allows a variety of processing possibilities and economic opportunities for various applications, including plasma deposition and plasma plating, etching, surface treatment, chemical decontamination, biological decontamination, and medical applications.

At one atmospheric pressure, due to the relative high breakdown voltage of working gases, the discharge gaps are normally from a few millimeters to several centimeters in range limiting the size of objects that can be treated directly. If indirect treatment (e.g., remote exposure) is used, certain short lifetime active species, such as oxygen atom, charge particles may already disappear before reaching the object to be treated, which makes the efficiency of treatment much lower. To address these concerns, non-equilibrium atmospheric pressure plasma jet devices have recently been attracting significant attention. The plasma jet devices generate plasma plumes in open space (e.g., the surrounding air) rather than in confined discharge gaps only. Thus, they can be used for direct treatment and there can be no limitation on the size of the objects to be treated.

Examples of conventional atmospheric pressure non-equilibrium plasma jet devices include: AC, RF, Microwave, and Pulsed DC Non-equilibrium plasma jet devices. Each of these devices is briefly described below.

AC Non-Equilibrium Plasma Jet Device

Referring to FIG. 1, an AC non-equilibrium plasma jet device with nitrogen as working gas, (an example of which is reported by Y. Hong et al “Microplasma Jet at Atmospheric Pressure” Appl. Physics Letters 89, 221504 (2006)), is illustrated. The device consists of an electrode 3, a grounding electrode 11 two centrally perforated dielectric disks 13, a dielectric container 12, and a power supply 1 (e.g., an alternating current (AC) power supply). Power supply 1 is connected to electrode 3 and grounding electrode 11. Electrode 3 and grounding electrode 11 are separated by dielectric disks 13, and all are inserted in dielectric container 12. Once a working gas 6 (nitrogen) is introduced with a flow rate of, 3 l/min into dielectric container 12, and AC high voltage with frequency of, 20 KHz from power supply 1 is applied, a discharge is fired in the gap between electrode 3 and grounding electrode 11, and a long plasma jet 5 reaching a length up to 6.5 cm can be ejected to the open air with a velocity of 255 m/s through a gas outlet 16. The gas temperature of plasma jet 5 can be close to room-temperature.

Because electrode 3 and grounding electrode 11 are in contact with plasma jet 5 directly, this leads to a discharge arc being formed easily when applying high voltage and is thus not safe for applications such as tooth cleaning, root canal disinfection, and acceleration of wound healing.

Referring to FIG. 2, similar to the above, an ac cold plasma jet generated by atmospheric dielectric barrier capillary discharge is disclosed (e.g., see Zhange et al Thin Solid Films 506 (2006)). The device includes electrode 3, grounding electrode 11, dielectric container 12, and a flow controller 8 and power supply 1 (e.g., an alternating current (AC) power supply). Electrode 3 is made of tungsten placed in the center of dielectric container 12 and is connected to power supply 1. Grounding electrode 11 can be placed on the outside wall of dielectric container 12. By adjusting flow controller 8 the flow rate of working gas 6 can be controlled, which is injected into dielectric container 12 through a gas inlet 7. When the AC voltage is applied, plasma jet 5 is generated. The main disadvantage of this device, inter alia, is that electrode 3 is directly contacted with plasma jet 5, which can also not be safe in certain applications.

RF Non-Equilibrium Plasma Jet Device

Referring to FIG. 3, a RF non-equilibrium plasma jet device is illustrated. More specifically a plasma needle for in vivo medical treatment is depicted (e.g., see Stoffels et al, Plasma Sources Sci. Technol. 15 (2006)). The device depicted includes electrode 3, dielectric container 12, a dielectric sheath 17 (e.g., a ceramic tube) and power supply 1 (e.g., a radio frequency (RF) power supply) connected with electrode 3. Electrode 3 can be made of, for example, tungsten having a diameter of about 0.3 mm placed in the center of dielectric sheath 17 having a diameter of about 4 mm, which both are attached to a fixed-mount 14. The right end of electrode 3 can be not covered by dielectric sheath 17. Working gas 6 (e.g., helium) flows into dielectric container 12 through gas inlet 7. When the RF voltage is applied, the plasma is generated with a size about 2.5 mm. One of the disadvantages of this device, inter alia, is that the end of electrode 3 can not be covered by dielectric sheath 17, and electrode 3 can be directly contacting with plasma, which is not safe for certain applications. Further, the length of plasma jet 5 can be very short with a high gas temperature. When the applied power is, for example, 3 W, the temperature of plasma jet 5 is about 90° C. and 50° C. at 1.5 mm and 2.5 mm from electrode 3, respectively.

Microwave Non-Equilibrium Plasma Jet Device

Recently, several new microwave plasma jet devices have been developed. However, the gas temperature of the plasma generated by most of these devices are relatively high, (i.e., at least several hundred degrees) which limits their applications for the treatment of temperature sensitive objects.

Pulsed DC Non-Equilibrium Plasma Jet Device

Referring to FIG. 4, a pulsed plasma jet called “plasma pencil” is illustratively depicted (e.g., see Xinpei Lu et al. “Dynamics of an atmospheric pressure plasma generated by submicrosecond voltage pulses” J. Appl. Phys. 100, 063302 (2006)). As shown, the device includes electrode 3, grounding electrode 11, dielectric container 12, two dielectric disks 13, a dielectric ring 15 and power supply 1 (e.g., a pulsed direct current voltage power supply) connected with electrode 3 and grounding electrode 11. Electrode 3 and grounding electrode 11 both can be made of a copper ring with the same diameter and attached to the surface of the centrally perforated dielectric disks 13. The dielectric ring 15 is placed between two dielectric disks 13. Electrode 3, grounding electrode 11, two dielectric disks 13, and dielectric ring 15 are inserted in the front space of dielectric container 12. When submicrosecond high voltage pulses from power supply 1 are applied to electrode 3, and working gas 6 (e.g., helium) is injected into dielectric container 12, plasma jet 5 of up to about 5 cm can be generated in the surrounding air. One of the disadvantages of this device is that arc discharge between electrode 3 and grounding electrode 11 can occur directly under certain conditions, such as when the pulse width is larger than 10 μs.

As above mentioned, most of the conventional plasma jet devices have disadvantages. Similar problems also exist for some recently patented plasma jet generating methods, apparatuses and systems. See U.S. Pat. No. 5,198,724 for “Plasma Processing Method and Plasma Generating Device” issued Mar. 20, 1993, U.S. Pat. No. 5,369,336 for “Plasma Generating Device” issued Nov. 29, 1994, both to Koinuma et al., U.S. Pat. No. 5,961,772 for “Atmospheric-pressure plasma jet” issued Oct. 5, 1999, and U.S. Pat. No. 6,262,523 for “Large area atmospheric-pressure plasma jet” issued Jul. 17, 2001, both to Gary S. Selwyn et al. These disadvantages limit the use of the non-equilibrium plasmas in various applications.

### SUMMARY OF THE TECHNOLOGY

The present technology discloses a RC plasma jet device. some embodiments of the technology may address one or more problems of current plasma jet devices, such as, but not limited to, high-voltage electrodes being unsafe and the possible arcing between the ground electrode.

The plasma jet device includes a power supply, a gas supply and an electrode. The working gas can be injected into the gas inlet of the electrode from the gas supply. The electrode, which is connected to the power supply through a resistance and a capacitor (RC) circuit, can be in the form of a hollow tube with a gas inlet and a gas outlet. In some embodiments, the electrode can include multiple gas outlets. Further still, the geometrical shape of the cross-section of the gas outlet of the electrode can be, for example, a circle, an ellipse, a racetrack-shape, a rectangle, a polygon, or a combination thereof.

In some embodiments of the technology, blowholes spread over the side of the electrode.

In some embodiments, the electrode can be jointed outside or inside a dielectric container, and the dielectric container can be in the form of a hollow tube with a gas inlet and a gas outlet. Optionally the dielectric container can include multiple gas outlets.

In some embodiments, a nozzle made of conductive material can be connected to the gas outlet of the electrode. The geometrical shape of the cross-section of the nozzle can be, for example, a circle, an ellipse, a racetrack-shape, a rectangle, a polygon or a combination thereof. Further still, blowholes may be formed to spread over the side of the nozzle.

The electrode can be connected to a power supply through a resistance and a capacitor. When the technology is employed, the resistance and capacitor can play the roles of adjusting the values of the high voltage applied to the electrode and the discharge current, and causing the space electric field and the discharge current to be adjustable, and therefore the length and cross-section and gas temperature of the generated plasma jet can be adjustable. When the gas temperature of the plasma jet is close to the desired temperature (e.g., room-temperature) the plasma jet can be safe for human contact. The working gases can be, for example, helium, oxygen, argon, nitrogen, mixture gas, air, gaseous compounds, gaseous organic compounds, which can be helpful for increasing the variety of reactive species inside the plasma jet.

The device can be portable, safe, easy to operate, and low cost, and available for various applications, such as plasma etching and deposition, surface treatment and decontamination, sterilization processes of food, tooth cleaning and root canal disinfection. Furthermore, according to different requirements of practical applications, the selection of different values of the capacitor and resistance, and use of different excitation sources and working gas permits, the gas temperature of the plasma jet to be adjusted. And, when the gas temperature is close to, for example, room-temperature, the plasma jet can be touched by a human hand without an arcing risk. Meanwhile, the plasma can be ejected to the open space with different geometric shapes by using different nozzles, as well as in any direction. The varieties and densities of the reactive species in the plasma can also be changed by using different working gases. Thus, large-scale applications at room-temperature and atmospheric pressure can be realized with various configurations.

### BRIEF DESCRIPTION OF THE DRAWINGS

The present technology is described herein below with reference to the accompanying drawings, in which:

FIG. 1 is a perspective view of a conventional AC non-equilibrium plasma jet device;

FIG. 2 is a perspective view of another conventional AC non-equilibrium plasma jet device;

FIG. 3 is a perspective view of a conventional RF plasma needle;

FIG. 4 is a perspective view of a conventional pulsed DC plasma pencil;

FIG. 5 is a perspective view of an embodiment of the present technology;

FIG. 6 is a perspective view of another embodiment of the present technology;

FIG. 7 is a perspective view of an embodiment of the present technology;

FIG. 8 is a perspective view of an embodiment of the present technology;

FIG. 9 is the cross-sectional view of an electrode adoptable to various embodiments of the technology;

FIGS. 10(a)-(b) are cross-sectional and side views of an electrode adoptable to various embodiments of the technology;

FIGS. 11(a)-(b) are the cross-sectional views of alternative nozzles in some embodiments of the technology;

FIG. 11(c) is the side view of alternative nozzles in accordance with some embodiments of the technology; and

FIG. 12 is a schematic for an experimental setup in accordance with some embodiments of the technology.

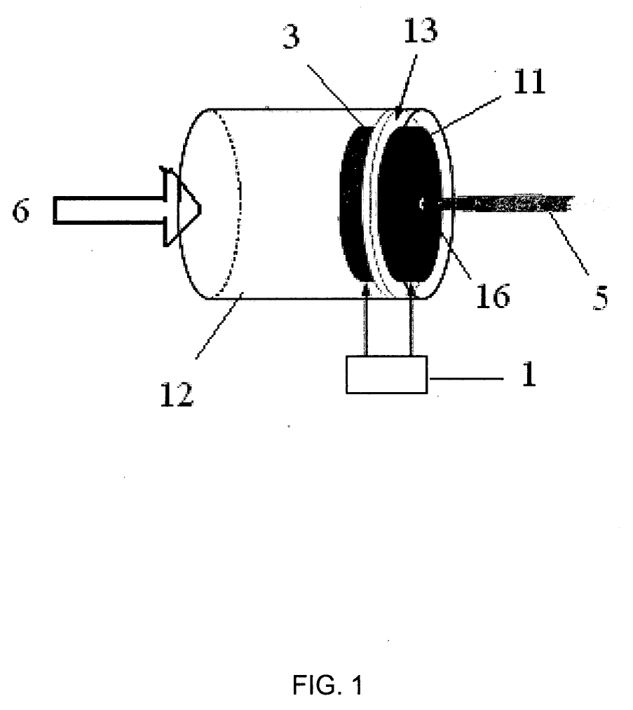

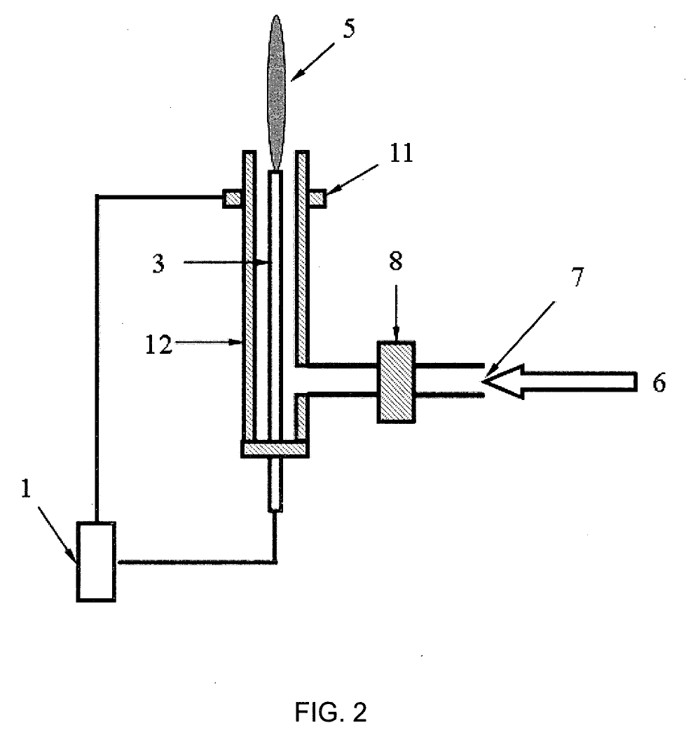

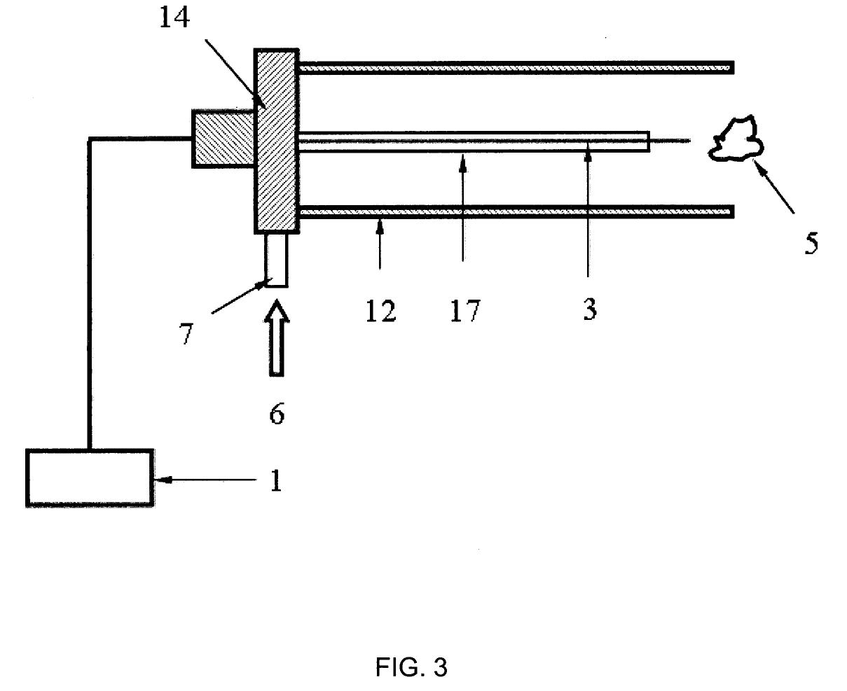

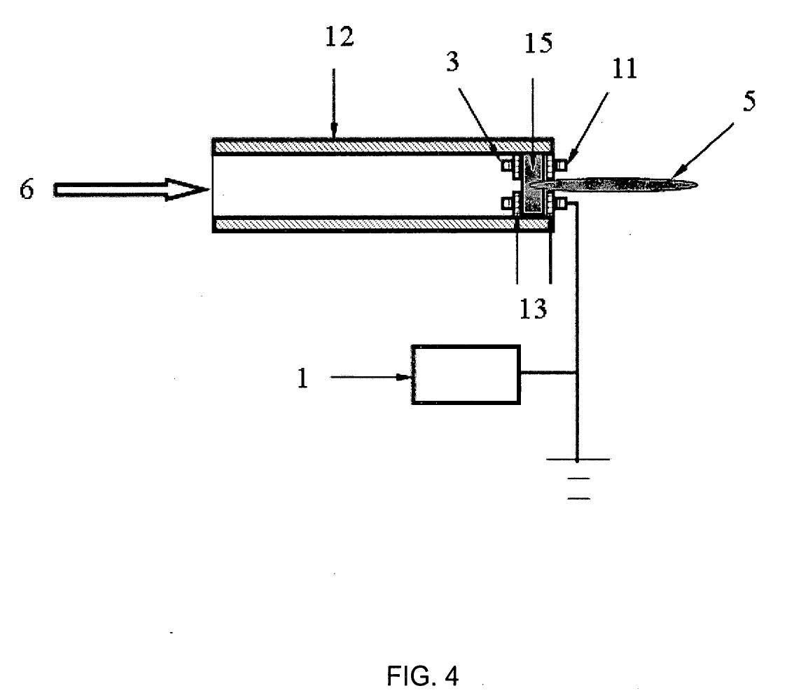

### DETAILED DESCRIPTION

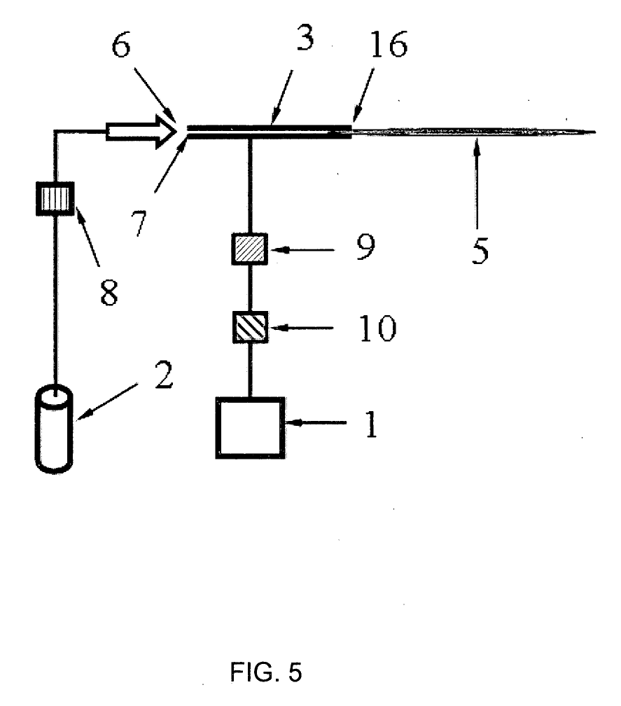

Referring to FIG. 5, a RC plasma jet device in accordance with some embodiments of the present technology is illustrated.

The device includes power supply 1, a gas supply 2, a resistor or resistance 9, a capacitor 10 and an electrode 3. The electrode 3, which can be made of a metal, such as, stainless steel, is connected to power supply 1 through the resistance 9 and capacitor 10. Electrode 3 can be in the form of a hollow tube and includes gas inlet 7 and gas outlet 16. By controlling the flow controller 8, the working gas 6 from the gas supply 2 can be injected into the electrode 3 through gas inlet 7. The generated plasma jet 5 is ejected to the open air through plasma outlet 16 of electrode 3.

In some instances, by adjusting the flow controller 8, a working gas 6 (e.g., helium) can be injected into electrode 3 with a flow rate of, for example, about 0.4 l/min. The values of the resistance 9 and the capacitor 10 can be, for example, about 8 KΩ and 1 pF, respectively. When the applied voltage (AC power) is adjusted to, for example, about 5 KV with the frequency at, for example, about 38 KHz, a high local electric field is induced in the discharge space in front of the gas outlet 16 of the electrode 3. Accordingly gas discharge occurs and a plasma jet 5 is generated. Because of the effects of the capacitive voltage divider by capacitor 10 and the resistive limit current by the resistor(s) or resistance 9, the gas temperature of plasma jet 5 can be close to room-temperature and can be touched by a human hand.

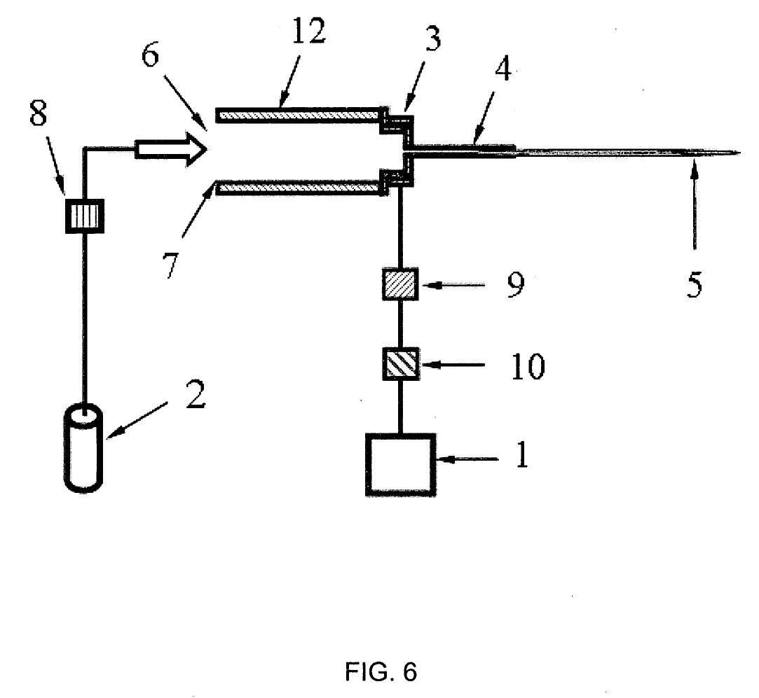

FIG. 6, has a perspective view of an alternative embodiment of the technology. The device includes power supply 1, gas supply 2, a resistance 9, a capacitor 10, a dielectric container 12 and an electrode 3. The electrode 3, which can be made of, for example, copper, or other metal, is connected to power supply 1 through the resistance 9 and the capacitor 10. The electrode 3 can be joined outside the gas outlet of the dielectric container 12. The dielectric container 12, can be made of, for example, PVC (polyvinyl chloride) or other suitable dielectric material, and the electrode 3 and container are both in form of hollow tubes. A nozzle 4, which can be made of, for example, copper, or other conducting metal, is connected to the gas outlet of electrode 3. By controlling the flow controller 8, the working gas 6 (e.g., nitrogen) provided from the gas supply 2 can be injected with a flow rate of, for example, about 2.0 l/min into the dielectric container 12 through the gas inlet 7. The generated plasma jet 5 is then ejected to the open air through nozzle 4.

In an example embodiment, the values of resistors or resistance 9 and capacitor(s) 10 can be about 500 Ω and 0.5 pF, respectively. The applied voltage amplitude (e.g., RF power) can be about 500 V with a frequency of about 13.65 MHz.

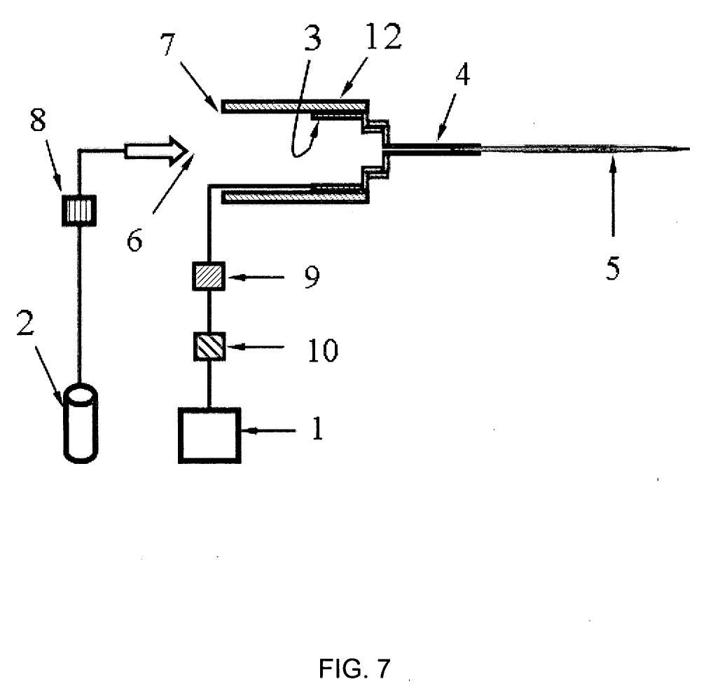

FIG. 7, shows a perspective view of yet another embodiment of the technology. The device includes a power supply 1, a gas supply 2, a resistor(s) or resistance 9, capacitor(s) 10, dielectric container 12 and electrode 3. The electrode 3, which can be made of, for example, aluminum, can be connected to power supply 1 through resistance 9 and capacitor 10. The dielectric container 12, which can be made of ceramic, and electrode 3, are both in form of hollow tubes. Electrode 3 can be joined inside the gas outlet of dielectric container 12. Nozzle 4 can be connected to the gas outlet of electrode 3 outside dielectric container 12. Nozzle 4 can be made of, for example, stainless steel or any suitable metal. By controlling flow controller 8, working gas 6 (e.g., argon) from gas supply 2 can be injected with a flow rate of, for example, about 1.0 l/min into dielectric container 12 through gas inlet 7. The generated plasma jet 5 is ejected to the open air through nozzle 4.

In some embodiments, the values of resistance 9 and the capacitance of capacitor 10 can be, about 6 KΩ and about 3 pF, respectively. The applied voltage amplitude (e.g., Pulse DC) can be about 6 KV with a frequency of about 4 KHz and pulse width of about 200 ns.

In some embodiments, electrode 3 can also be made of other conductive material, such as, but not limited to, tungsten; dielectric container 12 can also be made of plastic, quartz glass, prylex glass, or other dielectric material, with shape and size being adjusted in accordance with the requirements of the chosen application.

Referring back to FIG. 5, in some embodiments, nozzle 4 can also be connected to gas outlet 16 of electrode 3.

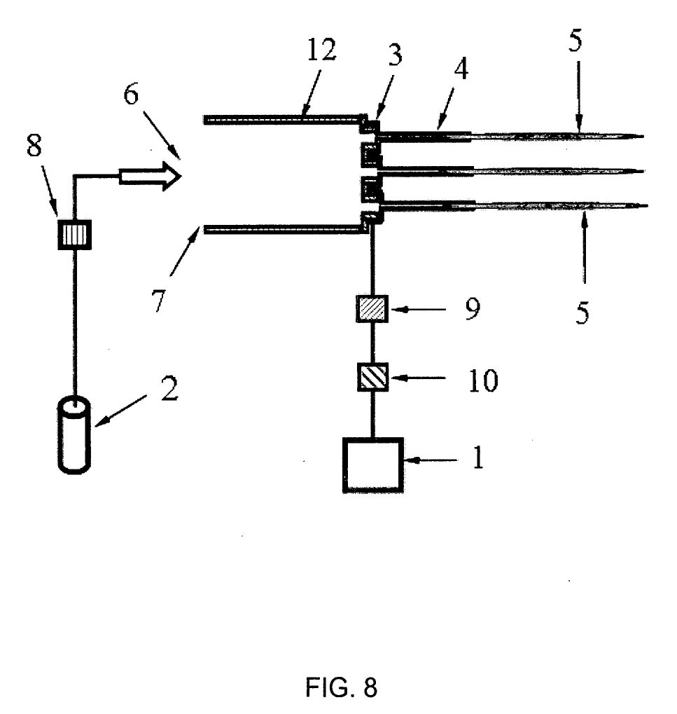

FIG. 8 a perspective view of yet another embodiment of the technology. The device includes power supply 1, gas supply 2, resistance 9, capacitor 10, dielectric container 12 and nine electrodes 3. Dielectric container 12, which can be made of, for example, PVC (polyvinyl chloride), or other dielectric is in the form of a hollow tube with nine gas outlets in three rows. By way of example, the nine electrodes 3 made of stainless steel are jointed outside the nine gas outlets, respectively. It will be understood that any reasonable plurality of electrodes can be used. And, each electrode 3 can be connected with nozzle 4. The nine electrodes 3 are connected to each other and all are connected to power supply 1 with one pair of a resistance 9 and a capacitor 10. By controlling flow controller 8, working gas 6 (e.g., air) from gas supply 2 can be injected with a flow rate of, for example, about 5.0 l/min into dielectric container 12 through gas inlet 7. The generated plasma jets 5 are ejected to the open air through each nozzle 4, respectively.

In some embodiments, the values of resistance 9 and capacitor 10 are, for example, about 20 KΩ and about 30 pF, respectively. The applied voltage amplitude (e.g., pulse DC) can be, for example, about 10 KV with a frequency of, for example, about 10 KHz and pulse width of about 200 ns. It will be understood that any reasonable alternative range could be used for resistance 9 and capacitor 10.

In some embodiments, each electrode 3 can also be connected to power supply 1 through one RC pair of (e.g., resistance 9 and capacitor 10, respectively) through which plasma jets 5 with different intensity and gas temperature can be generated.

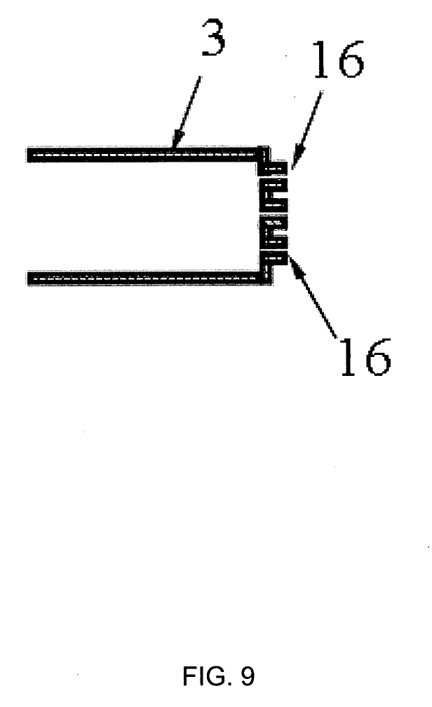

FIG. 9, is a cross-sectional view of an electrode useful for the embodiments previously described. By way of example, the electrode has six gas outlets 16 in two rows, and each gas outlet can be connected with a nozzle. In other embodiments, different numbers of gas outlets can be used.

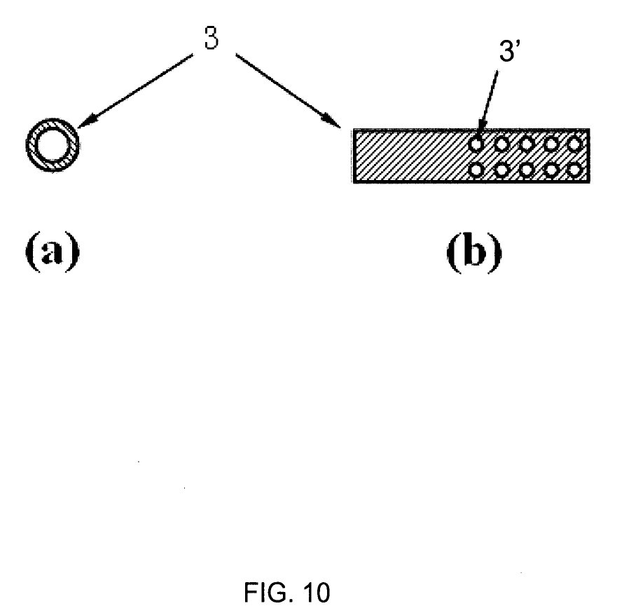

FIGS. 10(a)-(b), show cross-sectional and side views of an electrode having a circular cross-section. This embodiment includes ten blowholes 3′ in two rows spreading symmetrically over the side of the electrode.

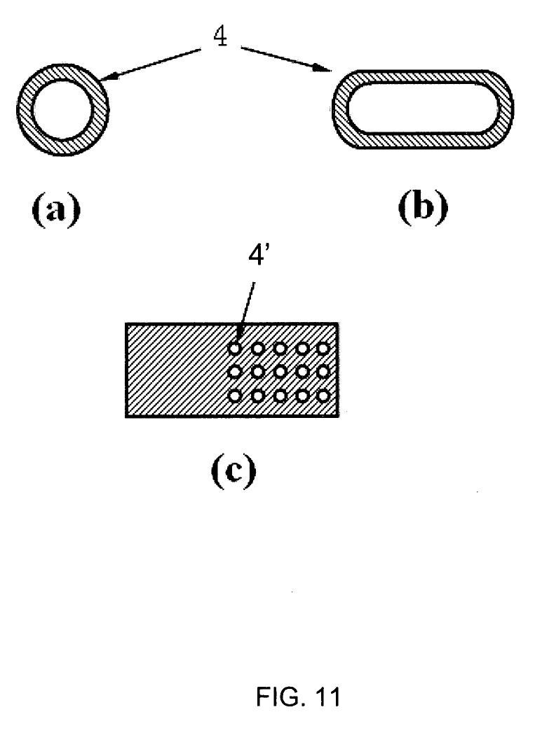

FIGS. 11(a)-(b) show cross-sectional views of alternative embodiments of the nozzle having a circular cross-section and a racetrack-shaped cross-section, which are suitable to generate plasma jets with a rod-shape and a sheet-shape, respectively.

FIG. 11(c) is the side view of an alternative embodiment of the nozzle that may be implemented in the embodiments previously. In this version, there are fifteen blowholes 4′ spanning symmetrically over the side of the nozzle, through which the generated plasma can be ejected to the open space in any direction. In this way, the treatment effects of some applications, like root canal disinfection and material surface treatment, can be improved. Other numbers of blowholes may be implemented symmetrically or asymmetrically over the side of the nozzle in other embodiments.

The alternative embodiments above, the cross-sections of electrode 3 and the nozzle can be formed as a circle, an ellipse, a racetrack-shape, a rectangle, a polygon or a combination thereof, which can be adjusted in accordance with the requirements of actual applications. Still other shapes for can also be used. Further, the value of resistance 9 can be more than, for example, about 1 Ω, and capacitor 10 can be less than, for example, about 10 F.

By way of example, in some instances, when power supply 1 generates an alternating current (AC), the ranges of the applied voltage and the frequency are, for example, about 220 V-60 KV and 50 Hz-13.6 MHz, respectively. When power supply 1 generates pulsed direct current power (Pulsed DC), the ranges of the applied voltage and the frequency are, for example, about 220 V-50 KV and 50 Hz-100 MHz, respectively, having a pulse-width of, for example, about more than 1 ns. The length of the generated plasma jet can be, in some instances, more than 0.1 mm, and the gas temperature of the plasma jet can be as low as room-temperature.

Further, by way of example, the above technology may be implemented as an application of cold plasma in sterilization of a root canal of a tooth. This can serve as a reliable and user-friendly plasma jet device, to generate plasma inside the root canal. The plasma can be touched by bare hands and can be directed manually by a user (e.g., a dentist) to place it into root canal for disinfection causing negligible, if any, painful sensation. For example, when He/O2 (20%) is used as a working gas, the rotational and vibrational temperatures of the plasma are about 300 K and 2700 K, respectively. The peak discharge current is about 10 mA. This can efficiently kill Enterococcus faecalis in several minutes, one of the main types of bacterium causing failure of root canal treatment.

For root canal disinfection, the principal methods include mechanic cleaning, irrigation, laser irradiation, ultrasound, application of hypochlorite, and other anti-bacterial compounds. Clinic studies show that there are about 10% of treatment failures when the traditional disinfection methods are used. The failures are mainly due to the presence of bacteria, which can not be completely sterilized by the methods mentioned above. Hence, a potential exists for using the above stated technology to help limit the negative affects of root canals.

For example, one potential method to improve the disinfection performance is by using atmospheric pressure cold plasmas. As stated above, atmospheric pressure cold plasmas can kill various types of bacteria, virus, and other harmful things to the human body. However, due to the narrow channel shape geometry of a root canal, which typically has a length of few centimeters and a diameter of one millimeter or less, the plasma generated by a plasma jet device is not efficient to deliver reactive agents into the root canal for disinfection. Therefore, to have a better killing efficacy, the plasma has too be generated inside the root canal. In other word, when plasma is generated inside the root canal, all kinds of reactive agents, including the short lifetime species, such as charge particles, could play some roles in the killing of bacteria. Therefore, it has a much better killing efficacy.

As described above, the application includes a reliable and user-friendly plasma jet device, which can generate plasma inside the root canal of a tooth. The plasma can be touched by, for example, bare hands and can be directed manually by a user (e.g., dentist) to place it into root canal for disinfection without causing any heating, electrical shock, or other painful sensation. This can efficiently kill Enterococcus faecalis, one of the main bacterium causing failure of root canal disinfection treatment. It should be noted that this technique may be used to kill other forms of bacteria.

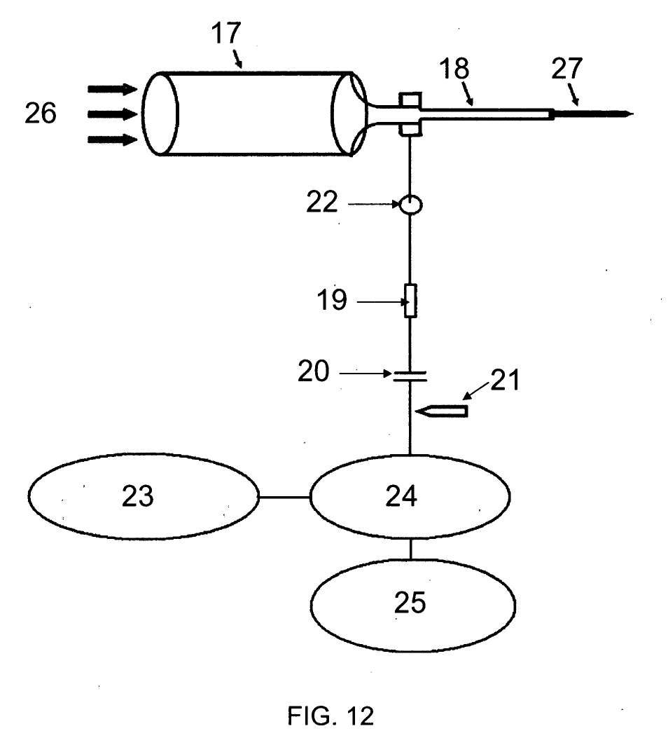

FIG. 12, by way of example, shows a schematic for an experimental embodiment setup of the technology. The main body of the device can be made of a medical syringe 18 and a needle 19. They are used for guiding the gas flow. The needle also serves as the electrode, which is connected to a high voltage (HV) sub-microsecond pulsed direct current (DC) power supply (e.g., amplitudes up to 10 KV, repetition rate up to about 10 KHz, and pulse width variable from about 200 ns to dc) through a about 60 KV ballast resistor 20 and about a 50 pF capacitor 21, where both resistor 20 and capacitor 21 are used for controlling the discharge current and the voltage on the needle. Because of the series connected capacitor 21 and resistor 20, the discharge current is limited to a safety range for a human. In some instances, if the resistance is too small or the capacitance is too large, there can be a feeling of weak electric shock when the plasma is touched by a human.

In some instances, the diameter of syringe 18 is about 6 mm and the diameter of the syringe nozzle is about 0.7 mm. Needle 19 has an inner diameter of about 200 μm and a length of 3 cm. It will be apparent that working gas such as He, Ar, or their mixtures with O2 can be used. The gas flow rate is controlled by a mass-flow controller (MFC).

The applied voltage is measured by a high voltage probe 22 (e.g., P6015 Tektronix high voltage probe) and current by current probe 23 (e.g., CT1 Tektronix current probe). The applied high voltage can be supplied by a DC power supply 24 connected to a high voltage pulse generator 25 which also receives a pulse signal from a pulse signal generator 26. The voltage and current wave forms are recorded by, for example, a Tektronix DPO7104 wideband digital oscilloscope. The optical emission spectra are measured by, for example, a half meter spectrometer (e.g., Princeton Instruments Acton SpectraHub 2500i). The resolution of the spectrum is about 0.4. During use, any of the above working gas flows 27 into syringe 18 and is converted to plasma 28.

Using the above-described experimental embodiment, the following results may be generated. When working gas such as He/O2 (20%) is injected into the hollow barrel of the syringe with a flow rate of 0.4 l/min and the HV pulsed DC voltage is applied to the needle, a homogeneous plasma is generated in front of needle. With this plasma produced a finger can make direct contact with the plasma, or even the needle without any feeling of warmth or electric shock. Therefore this device is safe for the application of root canal disinfection.

What is claimed is:

1. A resistor-capacitor plasma jet device, comprising:
a power supply, a gas supply and an electrode;
wherein a working gas is injected into a gas inlet of the electrode from the gas supply;
wherein the electrode is connected to the power supply through a resistance and a capacitance; and
the electrode is in the form of a hollow tube with a gas inlet and a gas outlet.

2. The device of claim 1, wherein the electrode comprises multiple gas outlets.

3. The device of claim 1, wherein blowholes spread over a side of the electrode.

4. The device of claim 2, wherein blowholes spread over a side of the electrode.

5. The device of claim 1, wherein a cross-sectional geometrical shape of the gas outlet of the electrode is at least one of a circle, an ellipse, a racetrack-shape, a rectangle, a polygon, or a combination thereof.

6. The device of claim 2, wherein a cross-sectional geometrical shape of the gas outlet of the electrode is at least one of a circle, an ellipse, a racetrack-shape, a rectangle, a polygon, or a combination thereof.

7. The device of claim 1, wherein the electrode is joined on at least one of the outside and inside the gas outlet of a dielectric container, and the dielectric container is in form of a hollow tube with a gas inlet and a gas outlet.

8. The device of claim 2, wherein the electrode is jointed on at least one of outside and inside the gas outlet of a dielectric container, and the dielectric container is in form of a hollow tube with a gas inlet and a gas outlet.

9. The device of claim 7, wherein the dielectric container comprises multiple gas outlets.

10. The device of claim 8, wherein the dielectric container comprises multiple gas outlets.

11. The device of claim 1, wherein a nozzle made of conductive material is connected to the gas outlet of the electrode;
a geometrical shape of a cross-section of the nozzle is at least one of a circle, an ellipse, a racetrack-shape, a rectangle, and a polygon, or a combination thereof.

12. The device of claim 2, wherein a nozzle made of conductive material is connected to the gas outlet of the electrode;
a geometrical shape of a cross-section of the nozzle is at least one of a circle, an ellipse, a racetrack-shape, a rectangle, and a polygon, or a combination thereof.

13. The device of claim 3, wherein a nozzle made of conductive material is connected to the gas outlet of the electrode;
a geometrical shape of a cross-section of the nozzle is at least one of a circle, an ellipse, a racetrack-shape, a rectangle, and a polygon, or a combination thereof.

14. The device of claim 4, wherein a nozzle made of conductive material is connected to the gas outlet of the electrode;
a geometrical shape of a cross-section of the nozzle is at least one of a circle, an ellipse, a racetrack-shape, a rectangle, and a polygon, or a combination thereof.

15. The device of claim 7, wherein a nozzle made of conductive material is connected to the gas outlet of the electrode;
a geometrical shape of a cross-section of the nozzle is at least one of a circle, an ellipse, a racetrack-shape, a rectangle, and a polygon, or a combination thereof.

16. The device of claim 8, wherein a nozzle made of conductive material is connected to the gas outlet of the electrode;
a geometrical shape of a cross-section of the nozzle is at least one of a circle, an ellipse, a racetrack-shape, a rectangle, and a polygon, or a combination thereof.

17. The device of claim 9, wherein a nozzle made of conductive material is connected to the gas outlet of the electrode;
a geometrical shape of a cross-section of the nozzle is at least one of a circle, an ellipse, a racetrack-shape, a rectangle, and a polygon, or a combination thereof.

18. The device of claim 10, wherein a nozzle made of conductive material is connected to the gas outlet of the electrode;
a geometrical shape of a cross-section of the nozzle is at least one of a circle, an ellipse, a racetrack-shape, a rectangle, and a polygon, or a combination thereof.

19. The device of claim 11, wherein blowholes spread over a side of the nozzle.

20. The device of claim 12, wherein blowholes spread over aside of the nozzle.

21. The device of claim 15, wherein blowholes spread over the side of a nozzle.

22. The device of claim 16, wherein blowholes spread over the side of the nozzle.

23. The device of claim 17, wherein blowholes spread over the side of the nozzle.

24. The device of claim 18, wherein blowholes spread over the side of the nozzle.
